(19) United States
(12) Patent Application Publication
(10) Pub. No.: US 2008/0307885 A1
(43) Pub. Date: Dec. 18, 2008

(54) Method and Apparatus for Precisely Measuring Wire Tension and Other Conditions, and High-Sensitivity Vibration Sensor Constructed in Accordance Therewith

(75) Inventors: Vladimir Ravitch, Ashkelon (IL); Michael Bernstein, Ashkelon (IL); Arie Ariav, Doar-Na Hof Ashkelon (IL)

Correspondence Address: MARTIN D. MOYNIHAN d/b/a PRTSI, INC., P.O. BOX 16446, ARLINGTON, VA, 22215, US

(73) Assignee: Nexense Ltd., Yavne (IL)

(21) Appl. No.: 11/884,781

(22) PCT Filed: Feb. 22, 2006
(86) PCT No.: PCT/IL06/00243

§ 371 Date: May 29, 2008

(30) Foreign Application Priority Data
Feb. 22, 2005 (IL) 167032
Feb. 22, 2005 (IL) 167033

(51) Int. Cl. G01N 29/07

(52) U.S. Cl. 73/597

(57) ABSTRACT

A method and apparatus for monitoring a predetermined condition of a medium by; transmitting acoustical waves through the medium, continuously measuring changes in the transit time of the acoustical waves resulting from changes in the monitored condition; and utilizing the changes in transit time to provide a continuous measurement of the changes in the monitored condition. The acoustical waves are bending waves wherein cross-sections of the medium have a rotational movement orthogonally to the axis of propagation of the waves through the acoustical channel. Several examples of such method and apparatus are described, including a highly sensitive pressure sensor for sensing changes in pressure applied to a displaceable membrane, and a highly-sensitive vibration sensor for sensing earth or other vibrations.

### FIELD AND BACKGROUND OF THE INVENTION

The present invention relates to a method and apparatus for monitoring predetermined conditions which influence the transit velocity of an acoustical wave through a medium. The invention is particularly useful for monitoring changes in tension of a tensioned member, especially of a wire, and is therefore described below with respect to such application. Two implementations of the invention are described below for purposes of example, including a highly-sensitive pressure sensor for sensing pressure changes as detected by a membrane, and a highly-sensitive vibration sensor for sensing vibrations in the earth or other bodies.

The present invention is particularly useful in the high-precision method and apparatus described in commonly-assigned U.S. Pat. No. 6,621,278 and published U.S. patent application Ser. No. 10/844,398, the contents of which patent and published application are expressly incorporated herein by reference. The invention is therefore described below with respect to such measuring method and apparatus, but it will be appreciated that various aspects of the present invention could be used in other methods and in other apparatus.

The above-cited U.S. patent and published U.S. patent application describe an extremely high-precision method and apparatus for measuring or monitoring various parameters or conditions, such as distance, displacement, temperature, pressure, force, etc., having a known relation to or influence on the transit time of movement of an energy wave through a medium. The method broadly involves transmitting a cyclically-repeating wave of the energy through a transmission channel in the medium; continuously changing the frequency of the transmission so as to maintain the number of waves in a loop including the transmission channel as a whole integer irrespective of changes in the monitored condition; and utilizing the changes in frequency of the transmission to provide a measurement of the parameter or an indication of the monitored condition. The described method enables the transit time of such an energy wave to be measured with extremely high precision, and therefore enables measuring or detecting with extremely high sensitivity virtually any parameter or condition that influences the transit time, e.g. the transit velocity and/or the transit distance, of the energy wave through the transmission channel.

The above-described method is sometimes referred to below as the FCWC (Frequency-Change by Wavelength Control) method, since it controls the frequency of the energy waves by maintaining whole integer wavelengths within the transmission channel. When the FCWC method is used for measuring tensile forces in a tensioned member, such as a wire, the change in transit time caused by the force being measured results predominantly from the change in transit distance resulting from the elongation of the member under tension. Thus, when the energy waves applied to the transmission channel medium are conventional longitudinal or transverse waves generated by conventional piezoelectric devices which alternatingly apply linear longitudinal or transverse forces to the member for propagation in the longitudinal direction, the velocity of the acoustical waves changes very little in the presence of tension in the member. The measurement of tensile force therefore is predominantly that resulting from the change in transit distance (elongation) of the member. Such elongation is very small relative to the tensile force, and therefore the sensitivity of the measuring method with longitudinal or transverse waves, although relatively high compared to the prior art, is relatively low compared to what is theoretically possible.

### OBJECTS AND BRIEF SUMMARY OF THE INVENTION

An object of the present invention is to provide a novel method and a novel apparatus for monitoring predetermined conditions which method and apparatus have a capability of extremely high sensitivity and precision. Another object of the invention is to provide a method an apparatus for precisely measuring tension in a tensioned member, especially in a tensioned wire. A still further object of the present invention is to provide a highly-sensitive vibration sensor particularly useful for measuring earth vibrations.

According to one aspect of the present invention, there is provided a method of monitoring a predetermined condition of a medium, comprising: transmitting, from a transmitter at a first location in the medium, an acoustical wave for propagation along an axis through the medium to a receiver at a second location in the medium such as to define an acoustical channel between the transmitter and receiver; continuously measuring changes in the transit time of the acoustical waves through the acoustical channel resulting from changes in the monitored condition; and utilizing the changes in transit time to provide a continuous measurement of the changes in the monitored condition; characterized in that the acoustical waves transmitted by the transmitter and received by the receiver are bending waves wherein cross-sections of the medium have a rotational movement orthogonally to the axis of propagation of the wave through the acoustical channel.

According to another aspect of the invention, there is provided apparatus for monitoring predetermined conditions, particularly the tension in a tensioned member, according to the above novel method.

As will be described more particularly below, the method and apparatus of the present invention, particularly when implemented by the FCWC method described in the above-cited patent and Published application, enable various conditions, particularly the tension in a tensioned wire, to be measured with extremely high sensitivity and precision. Other conditions such as temperature, influencing the transit velocity of an energy wave through a medium can also be measured with extremely high sensitivity by the method and apparatus of the present invention.

According to a further aspect of the invention, there is provided a vibration sensor of extremely high sensitivity for sensing vibrations of a body comprising: a base member to be brought into contact with the body; an arm pivotally mounted at one end to the base member; a mass carried by the arm such as to urge the opposite end of the arm in one direction; a spring engaging the arm such as to urge the opposite end of the arm in the opposite direction to a predetermined balanced position with respect to the base member; a damping device damping movements of the opposite end of the arm with respect to the base member; and a movement detector for detecting movement of the opposite end of the arm from the predetermined balanced position with respect to the base member.

Further features and advantages of the invention will be apparent from the description below.

### BRIEF DESCRIPTION OF THE DRAWINGS

The invention is herein described, by way of example only, with reference to the accompanying drawings, wherein:

FIG. 1 schematically illustrates one form of apparatus constructed in accordance with the present invention;

FIG. 2 illustrates the control and measuring system in the apparatus of FIG. 1;

FIGS. 3a and 3b are diagrams helpful in understanding one important aspect of the present invention and particularly the difference between a transverse shear wave (FIG. 3a) and a transverse bending or flexural wave (FIG. 3b);

FIG. 4a schematically illustrates one manner (by rotation excitation) of generating a bending wave;

FIG. 4b schematically illustrates another manner (by bending excitation) of generating a bending wave;

FIG. 5a illustrates the use of shear-polarized piezoelectric devices for generating a bending wave;

FIG. 5b illustrates the use of longitudinally-polarized devices for generating a bending wave;

FIG. 6 illustrates an example of an application of the present invention for measuring displacements of a membrane by measuring changes in tension in a tensioned wire coupled to the membrane;

FIG. 7 more particularly illustrates an application of the invention for measuring differential pressure on the opposite sides of a membrane;

FIG. 8 illustrates the invention for use in measuring changes in tension in a tensioned ribbon;

FIG. 9 illustrates another application of the invention for sensing vibrations;

FIG. 10 is an enlarged sectional view illustrating the pivotal mounting of the pivotal arm in the vibration sensor of FIG. 9;

FIGS. 11 and 12 are top plan views illustrating the two elastic leaves included in the pivotal mounting of FIG. 10;

FIG. 13 illustrates another vibration sensor constructed in accordance with another aspect of the present invention; and

FIG. 14 is a top plan view illustrating the reflector at the end of the pivotal arm in the vibration sensor of FIG. 13.

It is to be understood that the foregoing drawings, and the description below, are provided primarily for purposes of facilitating an understanding of the conceptual aspects of the invention and various possible embodiments thereof, including what is presently considered to be a preferred embodiment. In the interest of clarity and brevity, no attempt is made to provide more details that necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

### Overview

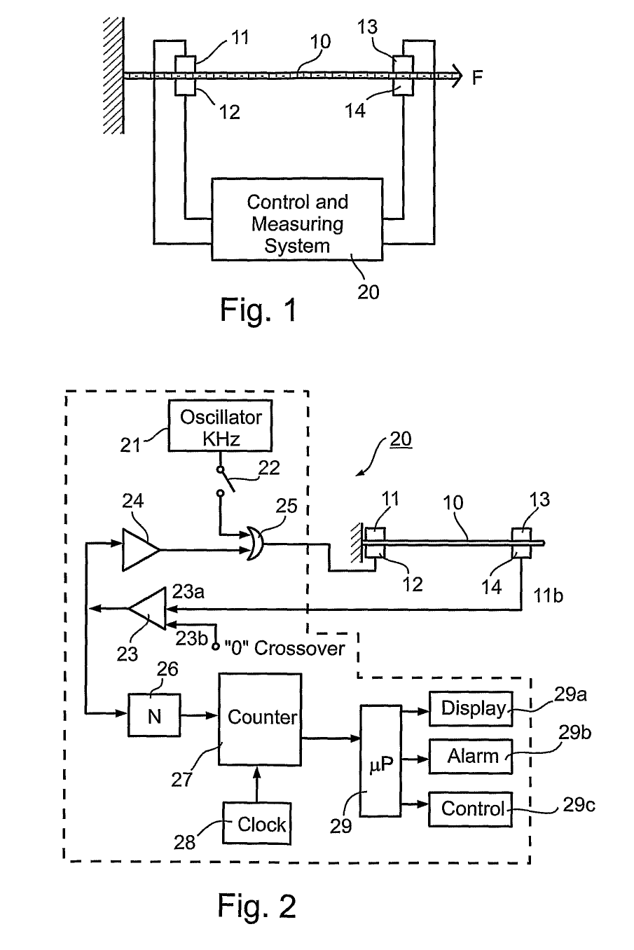

FIG. 1 illustrates the invention embodied in a tensioned wire 10, which is tensioned by a tensile force, indicated by arrow F, to be measured.

The illustrated apparatus includes a first pair of piezoelectric devices 11, 12 at a first location on the tensioned wire 10 for generating acoustical waves which propagate longitudinally along the length of the tensioned wire; and a second pair of piezoelectric devices 13, 14 at a second location, spaced from the first location of piezoelectric devices 11, 12 by at least one wavelength, for sensing or receiving the generated acoustical waves. The two pairs of piezoelectric devices 11, 12 and 13, 14 are controlled by a control and measuring system, generally designated 20, constructed as described in the above-cited US patent and published application and illustrated in FIG. 2 of the present application. As will be described more particularly below, system 20 controls piezoelectric devices 11, 12 so as to vary the frequency of the waves generated by them such that the number of wavelengths received by piezoelectric devices 13, 14 is a whole integer, and utilizes the variations in frequency at which the waves are generated to provide a measurement of the tensile force F.

Actually, system 20 produces a precise measurement of the transit times of the acoustical waves along the tensioned wire 10 from piezoelectric devices 11, 12 to piezoelectric devices 13, 14. The transit time varies with the transit velocity of the acoustical wave and with the transit distance from piezoelectric devices 11, 12 to the piezoelectric devices 13, 14. The variation in the transit distance, resulting from the elongation of the wire by the force F, is relatively small compared to the magnitude of the force applied.

On the other hand, the variation of the transit velocity with respect to the force applied can be relatively small or relatively large, depending on the nature of the acoustical waves generated by piezoelectric devices 11, 12.

### Bending Acoustical Waves

The generation of waves propagated along a medium involves two types of motions: (1) a unidirectional motion of the waves transferring the energy; and (2) a bidirectional motion of the particles producing the unidirectional motion of waves. Thus, in a longitudinal wave, the particles move bidirectionally in the direction of propagation of the longitudinal wave; whereas in a transverse wave, the particles move bidirectionally orthogonally to the unidirectional movement of the wave. The velocity of a longitudinal wave and of a transverse wave is relatively independent of tension on the medium through which the wave propagates; accordingly, any change in the transit time of such a wave will depend primarily on a change in the transit distance (e.g., produced by elongation), rather than a change in velocity.

On the other hand, a bending wave, sometimes called a “flexural wave”, changes its velocity through a tensioned member in accordance with the magnitude of the tension. Thus, an increase in the tension increases the transit velocity, and thereby decreases the transit time. The decrease in transit time caused by the tension is many times greater than the increase in transit time caused by an increase in the transit distance (elongation) produced by the tension. This characteristic is exploited in one aspect of the present invention in order to increase the precision and sensitivity of measuring a tensile force, or other condition, affecting the transit velocity of a bending wave through a tensioned member.

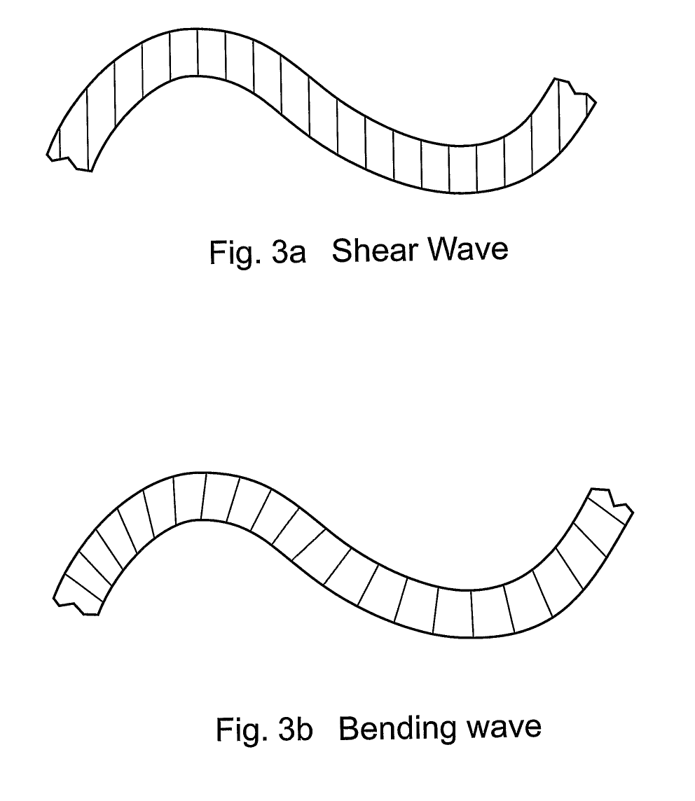

FIG. 3a schematically illustrates a conventional transverse wave, sometimes called a shear wave (or an S-wave), as propagated through a medium, such as a wire, having a thickness (diameter) substantially less than one wavelength; whereas FIG. 3b schematically illustrates a transverse bending wave, sometimes called a “flexural wave” as propagated through such a medium.

As shown in FIG. 3a, each particle in a conventional transverse or shear wave is displaced bidirectionally transversely to the axis of propagation of the wave according to a sine curve such that the cross-sections of the medium have a linear movement orthogonally to the axis of propagation of the wave.

As show in FIG. 3b, however, each particle of a bending wave is displaced bidirectionally angularly to the axis of propagation of the wave according to a sine curve, such that the cross-sections of the medium have a rotational movement orthogonally to the axis of propagation of the wave. In the bending waves, the bidirectional “bending” of these cross-sections produce the change in velocity of the wave in response to the tension applied to the medium (e.g., wire).

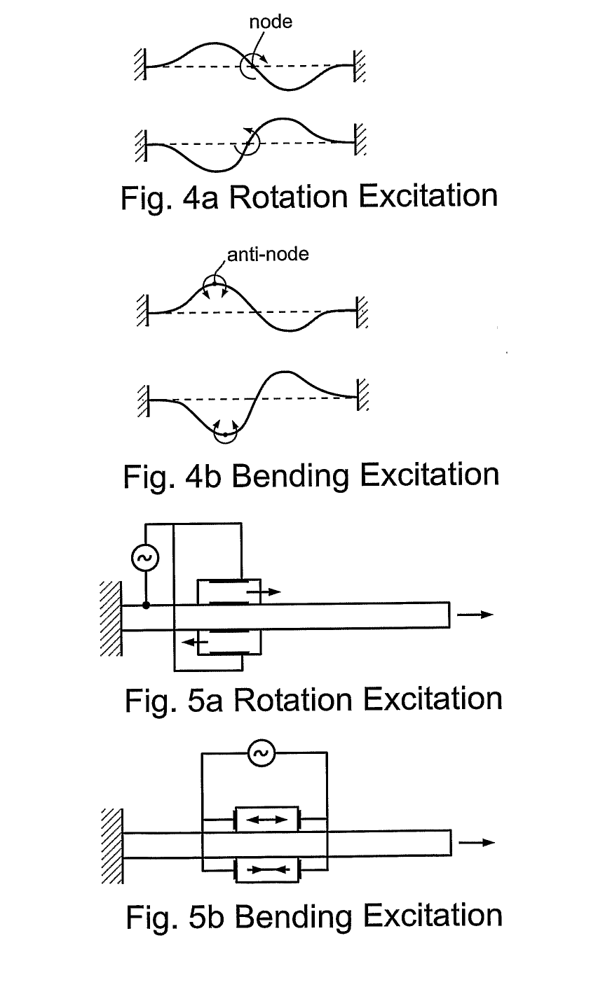

FIGS. 4a and 4b illustrate two different techniques which may be used for exciting the medium (e.g., wire) to produce bending waves by piezoelectric devices. In FIG. 4a, the piezoelectric devices excite the wire such as to rotate the beam, in which case the node of oscillation will be in the center of the piezoelectric devices. In FIG. 4b, the piezoelectric devices excite the wire so as to bend it, in which case the anti-node will be in the center of the piezoelectric devices.

FIGS. 5a and 5b illustrate two types of piezoelectric devices which may be used. In FIG. 5a, the piezoelectric devices are shear-polarized devices; that is, they experience shear oscillations and thereby create shear loads in the medium in opposite directions which rotate the medium cross-sections. In FIG. 5b, the piezoelectric devices are longitudinally polarized; that is, they experience longitudinal oscillations in which one piezoelectric device is elongated while the other is shortened in the same half-cycle, which thereby bend the medium cross-sections. The FIG. 5a devices operating according to the FIG. 4a technique is generally preferred.

As indicated above, a feature of the present invention is that piezoelectric devices 11, 12 and 13, 14 generate and receive, respectively, bending waves rather than conventional longitudinal waves or transverse waves. Bending waves propagate along a tensioned member at a velocity dependent on the tension in the member, the velocity increasing with an increase in the tensile force. This variation in velocity of bending waves in a tensioned member (e.g., wire) appears to be similar to the manner in which the velocity of a wave varies in a plucked guitar string in accordance with the tension applied to the guitar string. Thus, in a tensioned guitar string, the velocity (V) of the wave varies with the tension (t) and mass per unit length of the string (m), as follows:

V=\sqrt{t/m}

Since the velocity (V) is equal to the frequency (f) multiplied by the wavelength (A), it will be seen that the frequency of vibration of a tensioned string varies with the tensile force (t).

In any event, it has been found that the change in velocity of an acoustical bending wave propagated along a tensioned member (e.g., wire) when subjected to a tensile force is many times greater, in the order of ten times greater, than the change in distance (elongation) produced by the tensile force applied to the tensioned member. This phenomenon is used by one aspect of the present invention to provide a more sensitive method of measuring tensile force or other condition influencing the transit velocity of a bending wave through a medium.

### The Control and Measuring System 20 of FIGS. 1 and 2

The control and measuring system 20 of FIGS. 1 and 2 is basically the FCWC system described in the above-cited US patent and published patent application, except that they control piezoelectric devices 11, 12 to generate and transmit bending waves along the tensioned wire 10. Such bending waves are detected or received by piezoelectric devices 13, 14, which continuously change the frequency of piezoelectric devices 11, 12, irrespective of the magnitude of the tensile force F applied to the tensioned wire 10, so as to maintain the number of waves in the acoustical channel between the two pairs of piezoelectric devices as a whole integer. Control and measuring system 20 also utilizes the change in frequency of the transmitting devices 11, 12 to provide a continuous measurement of the changes in transit time of the acoustical waves from devices 11, 12 to devices 13, 14, and thereby a continuous measurement of the changes in the monitored condition, in this case, the magnitude of the tensile force F.

Initially, the bending waves are continuously generated by devices 11, 12 which are driven by an oscillator 21 (FIG. 2) under the control of a switch 22, until the waves are received by detector devices 13, 14. Once the waves are received, switch 22 is opened so that the received waves are thereafter used for controlling the frequency of transmission of the bending waves by devices 11, 12.

As shown in FIG. 2, detector devices 13, 14 produce output signals which are fed to a comparator 23 via its input 23a. Comparator 23 includes a second input 23b connected to a predetermined bias so as to detect a predetermined fiducial or reference point in the received signal. In the example illustrated in FIG. 2, this predetermined fiducial point is the “zero” crossover point of the received signal, and therefore input 23b is at a zero-bias. Other reference points could be used as the fiducial point, such as the maximum peaks, the minimum peaks, or the leading edge of the received signals.

The output of comparator 23 is fed to a monostable oscillator 24 which is triggered by each detected fiducial point to produce an amplified output signal. The signals from oscillator 24 are fed via an OR-gate 25 to the generator devices 11, 12. Accordingly, generator devices 11, 12 will excite the tensioned wire 10 at a frequency determined by the fiducial points in the bending waves received by sensor devices 13, 14 and detected by comparator 23. The frequency of transmission of the bending waves through tensioned wire 10 will therefore be such that the number of bending waves generated by transmitter devices 11, 12 and sensed by receiver devices 13, 14 is a whole integer, irrespective of any changes in the tensile force F applied to wire 10.

It will thus be seen that while the frequency of the transmissions will change with a change in the force F applied to tensioned wire 10, the number of wavelengths (λ) in the bending waves will remain a whole integer. This is because the transmissions by devices 11, 12 are controlled by the fiducial points of the signals received by devices 13. 14. This change in frequency, while maintaining the number of bending waves in the loop of the transmission channel as a whole integer, enables a precise determination to be made of the transit time through the transmission channel.

The signals outputted from comparator 23, which are used for controlling the frequency of the transmissions, are also fed to a counter 26 to be counted “N” times, and the output is fed to another counter 27 controlled by a clock 28. Counter 27 produces an output to a microprocessor 29 which performs the computations according to the parameter to be detected or measured. In this case, the parameter to be measured is the tensile force F on wire 10, or any parameter related to this tension.

As shown in FIG. 2, microprocessor 29 controls a display 29a for displaying its output, an alarm 29b for alerting a user as to a possible alarm condition, and/or a control 29c, which may be actuated when a particular condition is determined to be present.

Further details of the construction, use and other possible applications of the circuit of FIG. 2 are available in the above-cited U.S. Pat. No. 6,621,278, and published U.S. patent application Ser. No. 10/844,398, the contents of which are incorporated herein by reference.

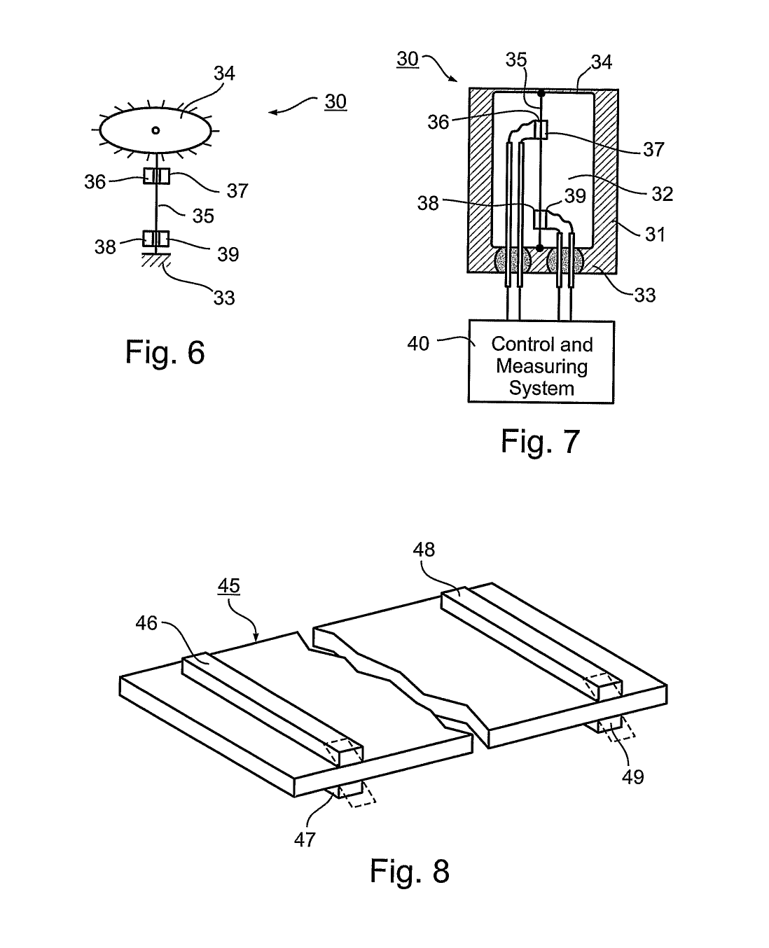

### The Tensioned Wire Embodiment of FIGS. 6 and 7

FIG. 6 illustrates, for purposes of example, one application of the above-described technique for measuring tension in a tensioned member such as wire 10. In the example illustrated in FIG. 6, the tensioned wire is secured to a displaceable membrane such that the measured variations in tension in the wire provide a measurement of the displacements of the membrane. FIG. 7 illustrates a particular application of the device of FIG. 6 wherein the membrane defines a wall of a chamber for containing a pressurized fluid, such that the measured displacements of the membrane are measurements of the pressure of the fluid within the chamber. For example, the device illustrated in FIG. 7 may be used as a barometer or altimeter of high sensitivity.

Thus, the device illustrated in FIGS. 6 and 7, therein generally designated 30, includes a housing 31 defining an internal chamber 32 filled with a fluid. One side of chamber 32 is defined by a rigid wall 33, and the opposite side by a displaceable membrane 34. For purposes of measuring the displacements of membrane 34 in response to the differential pressure on the opposite sides of the membrane, a wire 35 is tensioned between fixed wall 33 of housing 31 and displaceable membrane 34, such that variations in the differential pressure on the opposite sides of membrane 34 produce corresponding changes in tension in wire 35.

The changes in tension in wire 35 are measured by a bending wave generator, constituted of piezoelectric devices 36 and 37, at a first location on the wire; a bending wave detector, constituted of piezoelectric devices 38 and 39, at a second location on the wire; and a control and measuring system 40, all functioning as described above. Thus, the control and measuring system 40 varies the frequency at which the bending waves are generated by devices 36 and 37 such that the number of wavelengths detected by detector devices 38 and 39 is a whole integer, and utilizes the variation in frequency at which the bending waves are generated to provide a precise measurement of variations in the transit velocity of such waves. Such a measurement is also a precise measurement of the tensile forces applied to wire 35, and thereby of the displacements of membrane 34 producing such changes in the tensile force in the wire.

As described above, wire 35 should have a diameter substantially less than one wave length of the acoustical wave generated therein. For example, if the acoustical waves have a frequency in the order one MHz, the diameter of wire 35 should be less than 1 mm, preferably about 0.2 mm. Preferably, the wire should be pre-tensioned by at least 10% of the elastic limit, since such a pre-tension has been found to produce lower hysteresis in the operation of the apparatus.

### The Tensioned Ribbon Embodiment of FIG. 8

FIG. 8 illustrates another apparatus constructed in accordance with the invention utilizing, as the tensioned member, a ribbon 45, instead of a wire 35. Ribbon 45, e.g., of metal, should also have a thickness substantially less than one wavelength of the acoustical bending waves generated therein. The acoustical bending waves are generated in ribbon 45 by a pair of piezoelectric devices 46, 47 at one end, and are detected by another pair of piezoelectric devices 48, 49 spaced from devices 46, 47 by at least one wavelength, preferably a plurality of wave lengths. As described above, devices 46, 47 generate acoustical bending waves, and devices 48, 49 detect such waves and change the frequency of the wave generations to maintain a whole integer number of wavelengths in the transmission channel defined by the portion of the ribbon between devices 41, 42 and 43, 44, to produce a precise measurement of any condition, such as the change in tensile force, affecting the transit velocity through the respective transmission channel.

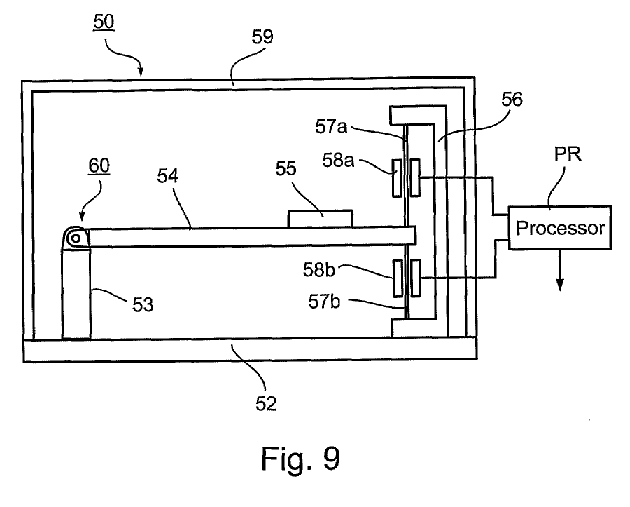

### The Vibration Sensor of FIGS. 9-12

FIGS. 9-12 illustrate a highly-sensitive vibration sensor, generally designated 50, for sensing vibrations in a body. The high-sensitivity capability of such a sensor makes it particularly useful as a seismometer for detecting earth vibrations, such as may result from earthquakes, oil or gas exploration operations, tunneling through the earth or other intrusions of monitored areas, etc.

Vibration sensor 50 illustrated in FIG. 9 includes a base member 52 to be brought into contact with the body (e.g., the earth) whose vibrations are to be sensed; an upright 53 at one end of the base member 52; an arm 54 pivotally mounted at one end to upright 53; and a mass 55 carried by arm 54 such as to urge the opposite end of the arm towards base member 52. Another upright 56 is secured to base member 52 at the opposite end of arm 54. A first wire 57a is tensioned between the opposite end of arm 54 and upright 56 urging the wire upwardly, i.e., in the opposite direction from mass 55; and a second wire 57b is tensioned between the opposite end of arm 54 and upright 56, tensioned to urge the ann in the same direction as mass 55. Each of the tensioned wires 57a, 57b includes an acoustical channel, shown at 58a and 58b, respectively, each including a pair of bending wave generators and a pair of sensors spaced therefrom as described above, for measuring the transit time of bending waves through the respective channel for producing a highly-sensitive measurement of tension in the respective wire.

Vibration sensor 50 further includes a housing 59 to prevent air movements from affecting its operation.

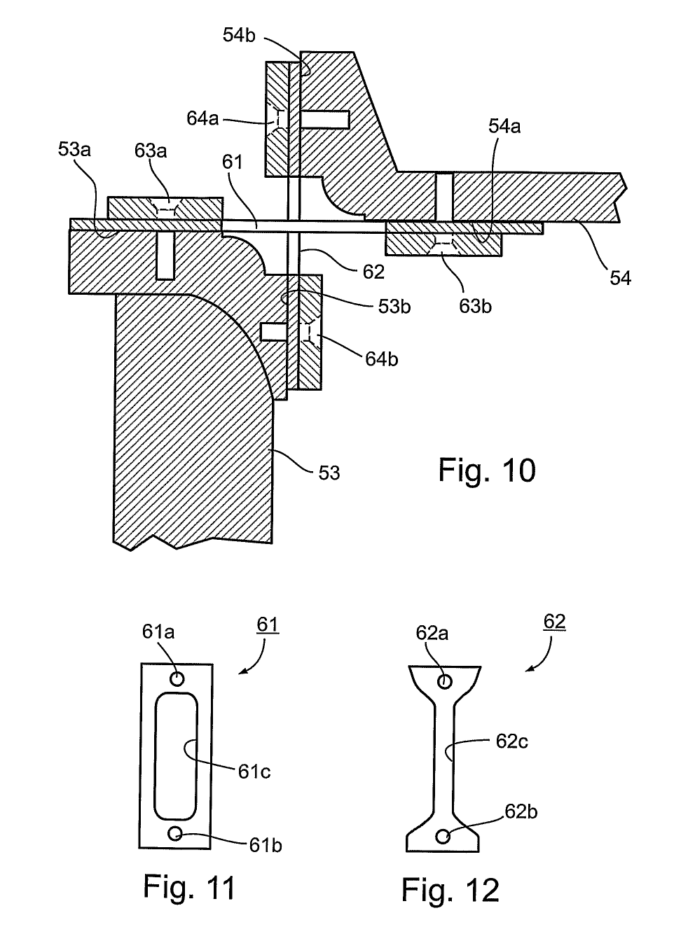

The pivotal mounting of arm 54 to post 53 of base member 52, is schematically shown at 60 in FIG. 9, and is more particularly illustrated in FIGS. 10-12. Thus, as shown in FIG. 10, post 53 terminates in a horizontally-extending surface 53a and a vertically-extending surface 53b perpendicular to surface 53a; and similarly, arm 54 terminates in two corresponding perpendicular surfaces 54a, 54b extending perpendicularly to each other. Pivotal mounting 60 is effected by two flat elastic leaves 61, 62, of constructions more particularly illustrated in FIGS. 11 and 12, respectively, fixed to the two perpendicular surfaces 53a, 53b of post 53, and 54a, 54b of arm 54, such that the two leaves 61, 62 are perpendicular to each other.

Thus, as shown in FIG. 11, leaf 61 is formed with a pair of openings 61a, 61b at its opposite ends, and an elongated slot 61c inbetween. Leaf 62 is similarly formed with a pair of openings 62a, 62b at opposite ends, but with a narrow web portion 62c inbetween. Web portion 62c is of a width less than the width of slot 61c in leaf 61 so as to be freely movable within that slot when the two leaves are used for monitoring pivotal arm 54 to post 53.

As shown particularly in FIG. 10, leaf 61 is mounted to the horizontal surfaces 53a, 54a of post 53 and arm 54, respectively, by fasteners 63a, 63b passing through openings 61a, 61b; similarly, leaf 62 is mounted to the vertical surfaces 53b, 54b of post 53 and arm 54 respectively, by fasteners 64a, 64b, passing through openings 62a and 62b respectively. It will be seen that when the two flat elastic leaves 61, 62 are so mounted to their respective surfaces of post 53 and arm 54, the two flat elastic leaves 61, 62 are perpendicular to each other, with web 62c of leaf 62 received within slot 61c of leaf 61.

Such a construction produces a pivotal mounting which imposes extremely low resistance to small pivotal movements of arm 54, and which constrains its pivotal movements to those perpendicular to the pivot axis.

In use, vibration sensor 50 illustrated in FIG. 9 is applied so that its base 52 directly contacts the body whose vibrations are to be monitored. Thus, the occurrence of vibrations will change the tension in the two tension wires 57a, 57b, which changes in tension will be detected and measured in a highly-sensitive manner by the two acoustical channels 58a, 58b, defined by such wires. The outputs of the two transmission channel 58, 58b, are applied to a processor PR. Processor PR produces an output which is additive with respect to the changes in tension in the two wires 57a, 57b, but which is subtractive with respect to temperature or other extraneous factors influencing the measurements produced in the two tension wires, thereby providing a highly-sensitive vibration sensor.

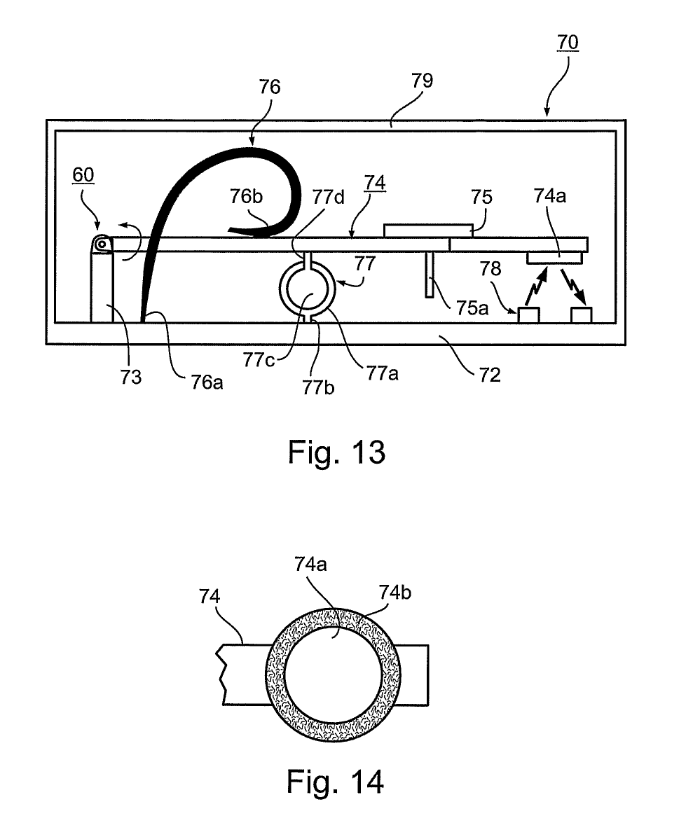

### The Vibration Sensor of FIGS. 13 and 14

FIGS. 13 and 14 illustrate another vibration sensor of similar construction as described above with respect to FIGS. 9-12, but using the basic method described in the above-cited U.S. Pat. No. 6,621,278, rather than bending waves as described above, for detecting vibrations. In this case, the vibration sensor uses a movement detector for detecting displacements of the free end of the pivotal arm, rather than tensioned wires for this purpose.

As shown in FIG. 13, the illustrated vibration sensor, therein designated 70, includes a base member 72 to be brought into contact with the body (e.g. the earth) whose vibrations are to be sensed; an upright 73 at one end of the base member 72; and an arm 74 pivotally mounted at one end to upright 73 of the base member. The illustrated vibration sensor further includes a mass 75 carried by arm 74 such as to urge the opposite end of the arm towards base member 72, and a spring 76 engaging a mid-portion of arm 74 such as to urge the opposite end of the arm away from base member 72 to a predetermined balanced position (as shown in FIG. 13) with respect to the base member. The movements of arm 74 are dampened by a damping device, generally designated 77.

The illustrated vibration sensor further includes a movement detector, generally designated 78, for detecting movements of the opposite (free) end of arm 74 from the predetermined balanced position with respect to the base member. In this case, movement detector 78 is preferably of the acoustical wave type as described in our U.S. Pat. No. 6,621,278. All the foregoing elements of the vibration sensor are enclosed within a housing 79 to prevent air movements from affecting its operation.

The pivotal mounting of arm 74 to post 73 is preferably the same as described above with respect to FIGS. 9-12. Accordingly, this pivotal mounting is also generally designated 60 in FIG. 13, as in FIG. 9 and as more particularly described with respect to FIGS. 10-12.

As indicated above, mass 75 carried by arm 74 urges the arm towards base member 72, whereas spring 76 urges the arm away from the base member to a predetermined balanced position with respect to the base member. As shown in FIG. 13, spring 76 is a coiled leaf spring having one end 76a secured to base member 72, and the opposite end 76b secured to arm 74.

Movements of arm 74 are dampened by damping device 77 so as to produce a low resonant frequency with respect to the pivotal movements of the arm. For this purpose, damping device 77 includes a magnet 77a secured at 77b to base member 72, and an electrically-conductive member in the form of a thin copper disc 77c secured at 77d to arm 74. Electrically-conductive disc 77c is located proximal to magnet 77a such as to generate electrical eddy currents in the disc when moved by the arm with respect to magnet 71a, and thereby to dampen the movements of the arm with respect to base member 72.

The illustrated vibration sensor senses vibrations of the body contacted by base 72, by detecting movements of the free end of arm 74 (i.e., the end opposite to its pivotal mounting 60) from the predetermined balanced position. The latter position is produced by mass 75 urging the arm towards base member 72, and spring 76 urging the arm away from the base member. Any movement detector monitoring the free end of arm 74 could be used for this purpose, such as a capacitance-type detector, or an optical-type detector. Particularly good results, however, have been obtained when the movement detector is an acoustical-type detector of the construction described in the above-cited U.S. Pat. No. 6,621,278.

For this purpose, the free end of arm 74 carries a flat reflector disc 74a as shown in FIG. 14 overlying the acoustical detector 78. Disc 74a is highly reflective with respect to acoustical waves. It is circumscribed about its periphery by a sound-absorbing material 74b, e.g. cotton. Such sound-absorbing material reduces extraneous noise in the output of the movement detector 78 by preventing multiple-reflections of the sound waves from the reflecting surface of disc 74a.

The vibration sensor illustrated in FIG. 13 and 14 is capable of detecting any movement of the reflector disc 74a carried at the end of pivotal arm 74 with a resolution of the order of 0.1 micron.

Pivotal arm 74 is isolated from any air currents by the outer housing 79. Housing 79 is preferably of a transparent material to enable viewing the various elements of the vibration sensor. The interior of housing 79 may also be coated or lined with sound-absorbing material to further reduce noise arising from multiple reflections of the acoustical waves.

The manner of using the illustrated vibration sensor will be apparent from the above description.

Thus, if the vibration sensor is to be used for sensing vibrations in the ground, its base member 72 would be placed on the ground, to freely rest on the ground or to be secured to the ground. Mass 75 is preferably adjustably mounted to arm 74, e.g. by a depending stem 75a movable within a longitudinal slot in the arm so that it can be moved along this arm in order to balanced the arm against spring 76 to a predetermined balanced position with respect to the base member 72.

Because of the low resonant frequency of pivotal arm 74 as described above, very slow movements of the base member 72 produced by small movements of the earth (e.g., by temperature changes), will not result in any displacement of arm 74 from its predetermined balanced position with respect to the base member since the arm will follow the base member in such movements. However, vibrations in the ground at a frequency higher than the resonant frequency of the pivotal arm will produce a displacement of the free end of the arm carrying the reflector disc 74a with respect to the base member 72 from the predetermined balanced position of the arm, and this displacement will be detected by movement detector 78 in the manner described above.

While the invention has been described with respect to several preferred embodiments, it will be appreciated that these are set forth merely for purposes of example, and that many other variations, modifications and applications of the invention may be made. For example, the ribbon sensor of FIG. 8 could be used for one or both of the leaves 61, 62 to detect flaring in the respective leafs. Also, the described core sensor or ribbon sensor could be used for detecting other conditions, e.g., temperature change. Many other variations and applications of the invention will be apparent.

What is claimed is:

1. A method of monitoring a predetermined condition of a medium, comprising:
transmitting, from a transmitter at a first location in said medium, acoustical waves for propagation along an axis through said medium to a receiver at a second location in said medium such as to define an acoustical channel between said transmitter and receiver;
continuously measuring changes in the transit time of the acoustical waves through said acoustical channel resulting from changes in said monitored condition;
and utilizing said changes in transit time to provide a continuous measurement of the changes in the monitored condition;
characterized in that said acoustical waves transmitted by said transmitter and received by said receiver are bending waves wherein cross-sections of the medium have a rotational movement orthogonally to the axis of propagation of the waves through said acoustical channel.

2. The method according to claim 1, wherein said changes in the transit time are continuously measured by continuously changing the frequency of said transmitter so as to maintain the number of waves in said acoustical channel as a whole integer irrespective of changes in said monitored condition; and wherein the changes in frequency of said transmitter are utilized to provide a continuous measurement of the changes in the monitored condition.

3. The method according to claim 3, wherein the frequency of the transmission of the bending waves through said acoustical channel is continuously changed by detecting a predetermined fiducial point in each wave received by the receiver at said second location, and utilizing said detected fiducial point for triggering the transmitter to generate the next wave at said first location.

4. The method according to claim 1, wherein said medium is a tensioned member having a thickness of less than one wavelength; and wherein said condition being monitored is the tension of said tensioned member.

5. The method according to claim 4, wherein said tensioned member is a tensioned wire, and said condition being monitored is the tension of said wire.

6. The method according to claim 4, wherein said tensioned member is a tensioned ribbon, and said condition being monitored is the tension of said ribbon.

7. The method according to claim 1, wherein said bending waves are generated and received by shear-polarized piezoelectric devices.

8. The method according to claim 1, wherein said bending waves are generated and received by longitudinally-polarized piezoelectric devices.

9. The method according to claim 1, wherein said medium is a tensioned wire coupled to a pressure-displaceable membrane, and said condition being monitored is the displacement of said membrane and, thereby, the pressure producing said displacement.

10. The method according to claim 1, wherein said medium is a tensioned wire coupled to a vibration-displaceable arm, and said condition being monitored is the displacement of said arm and, thereby, the vibrations in a body producing said displacement.

11. Apparatus for monitoring a predetermined condition of a medium, comprising
a transmitter at a first location of said medium for transmitting acoustical waves for propagation along an axis through said medium;
a receiver at a second location of said medium for receiving said transmitted acoustical waves;
and a processor continuously measuring changes in the transit time of the acoustical waves from said transmitter to said receiver resulting from changes in said monitored condition, and for utilizing said changes in transit time to provide a continuous measurement of the changes in the monitored condition;
characterized in that said acoustical waves transmitted by said transmitter and received by said receiver are bending waves wherein cross-sections of the medium have a rotational movement orthogonal to the axis of propagation of the waves through said acoustical channel.

12. The apparatus according to claim 11, wherein said processor continuously measures changes in the transit times by continuously changing the frequency of said transmitter so as to maintain the number of waves between said transmitter and receiver as a whole integer irrespective of changes in said monitored condition; and wherein said processor utilizes the changes in frequency of said transmitter to provide a continuous measurement of the changes in the monitored condition.

13. The apparatus according to claim 12, wherein said processor continuously changes the frequency of the transmission of the bending waves through said acoustical channel by detecting a predetermined fiducial point in each wave received by the receiver at said second location, and utilizing said detected fiducial point for triggering the transmitter to generate the next wave at said first location.

14. The apparatus according to claim 11, wherein said medium is a tensioned member having a thickness less than one wavelength; and wherein said condition being monitored is the tension of said tension member.

15. The apparatus according to claim 14, wherein said tensioned member is a tensioned wire, and said condition being monitored is the tension of said wire.

16. The apparatus according to claim 14, wherein said tensioned member is a tensioned ribbon, and said condition being monitored is the tension of said ribbon.

17. The apparatus according to claim 11, wherein said bending waves are generated and received by shear-polarized piezoelectric devices.

18. The apparatus according to claim 11, wherein said bending waves are generated and received by longitudinally-polarized piezoelectric devices.

19. The apparatus according to claim 11, wherein said medium is a tensioned wire coupled to a pressure-displaceable membrane, and said condition being monitored is the displacement of said membrane and, thereby, the pressure producing said displacement.

20. The apparatus according to claim 11, wherein said medium is a tensioned wire coupled to a vibration-displaceable arm, and said condition being monitored is the displacement of said arm and, thereby, vibrations in a body coupled to said arm to produce said displacement.

21. The apparatus according to claim 20, wherein said apparatus further comprises:
a base member to be brought into contact with said body whose vibrations are being monitored, said arm being pivotally mounted to one end of said base member;
and a mass carried by said arm such as to urge the opposite end of the arm by gravity in one direction;
said wire being coupled to said opposite end of the arm and tensioned to urge the arm in the opposite direction such as to monitor the changes in tension caused by vibrations in said body in contact with said base member.

22. The apparatus according to claim 21, wherein said apparatus further comprises:
a second tensioned wire coupled to said opposite end of the arm but tensioned to urge the arm in said one direction;
and a second transmitter and a second receiver at spaced locations in said second tensioned wire;
said processor also continuously measuring changes in the transit time of the acoustical waves from said second transmitter to said second receiver resulting from changes in tension in said second tensioned wire, and producing an output which is additive with respect to the two change-in-tension measurements in the two tensioned wires, but subtractive with respect to temperature and other extraneous factors influencing such measurements.

23. The apparatus according to claim 21, wherein said arm is pivotally mounted to said base member by a first flat elastic leaf secured at its opposite ends to the base member and said pivotal arm, respectively, and a second flat elastic leaf secured at its opposite ends to said base member and said pivotal arm, respectively, perpendicularly to said first flat elastic leaf; one of said flat elastic leaves being formed with an elongated slot for receiving the other of said flat elastic leaves.

24. The apparatus according to claim 21, wherein said pivotal arm is enclosed by a housing to reduce noise or eliminate air movements with respect to said pivotal arm.

25. A vibration sensor for sensing vibrations of a body comprising:
a base member to be brought into contact with said body;
an arm pivotally mounted at one end to said base member;
a mass carried by said arm such as to urge the opposite end of the arm in one direction;
a spring engaging said arm such as to urge said opposite end of the arm in the opposite direction to a predetermined balanced position with respect to said base member;
a damping device damping movements of said opposite end of the arm with respect to said base member;
and a movement detector for detecting movement of said opposite end of the arm from said predetermined balanced position with respect to said base member.

26. The vibration sensor according to claim 25, wherein said pivotal arm has a resonant frequency of less than one Hz.

27. The vibration sensor according to claim 25, wherein said arm is pivotally mounted to said base member by a first flat elastic leaf secured at its opposite ends to the base member and said pivotal arm, respectively, and a second flat elastic leaf secured at its opposite ends to said base member and said pivotal arm, respectively, perpendicularly to said first flat elastic leaf; one of said flat elastic leaves being formed with an elongated slot for receiving the other of said flat elastic leaves.

28. The vibration sensor according to claim 25, wherein said damping device includes a permanent magnet secured to said base, and an electrically-conductive member carried by said arm proximal to said magnet such as to generate electrical eddy currents therein when moved by said arm.

29. The vibration sensor according to claim 25, wherein said spring is a coiled leaf spring which engages a mid-portion of said pivotal arm.

30. The vibration sensor according to claim 25, wherein said base member is constructed such as to be brought into contact with the body whose vibration is to be sensed with said pivotal arm overlying the base member such that the mass urges said opposite end of the pivotal arm towards base member, and said spring urges said opposite end of the pivotal arm away from said base member.

31. The vibration sensor according to claim 25, wherein said movement detector is an acoustical wave detector which detects any change in the transit time of an acoustical wave caused by movement of said opposite end of the pivotal arm from said predetermined balanced position with respect to said base member.

32. The vibration sensor according to claim 31, wherein said acoustical wave detector comprises:
a transmitter for transmitting a cyclically-repeating acoustical wave towards said opposite end of the pivotal arm;
a receiver for receiving the cyclically-repeating acoustical wave reflected from said opposite end of pivotal arm;
and a processor for continuously changing the frequency of said transmitter such that the number of waves received by said receiver is a whole integer, and for utilizing a change in frequency of the transmitter to detect a change in the transit time of the acoustical wave from said transmitter to said receiver, and thereby to detect movement of said opposite of the pivotal arm from said predetermined balanced position with respect to said base member.

33. The vibration sensor according to claim 32, wherein said opposite end of the pivotal arm carries an acoustical wave reflector which reflects the acoustical wave towards the receiver.

34. The vibration sensor according to claim 33, wherein said acoustical wave reflector is circumscribed by an acoustical wave absorber to reduce noise caused by undesired reflections from said reflector.

35. The vibration sensor according to claim 25, wherein said pivotal arm is enclosed by a housing to reduce noise or eliminate air movements with respect to said pivotal arm.
